(19) United States
(12) Patent Application Publication
(10) Pub. No.: US 2026/0244146 A1
(43) Pub. Date: Aug. 20, 2026

(54) SHEET CONVEYANCE APPARATUS

(71) Applicant: CANON KABUSHIKI KAISHA, Tokyo (JP)

(72) Inventor: ISAO ITAGAKI, Chiba (JP)

(21) Appl. No.: 19/537,894

(22) Filed: Feb. 12, 2026

(30) Foreign Application Priority Data
Feb. 18, 2025 (JP) 2025-024580

(51) Int. Cl. G03G 15/00; B65H 5/06

(52) U.S. Cl. CPC G03G 15/6529; B65H 5/062

(57) ABSTRACT

A sheet conveyance apparatus includes a first guide, a second guide, a conveyance roller pair including a first roller, and a second roller, a pressing member configured to press the second roller toward the first roller in a state where the second roller abuts against the first roller, a drive source configured to move the second roller between the first position and the second position, and a control unit configured to execute a separating process of controlling the drive source to position the second roller at the second position, and an abutment process of controlling the drive source so that the second roller moves from the second position to the first position. The second roller is positioned at the second position in a case where the second guide moves from the open position to the closed position.

### BACKGROUND

### Field of the Technology

The present disclosure relates to a sheet conveyance apparatus that conveys a sheet.

### Description of the Related Art

Japanese Patent Application Laid-Open Publication No. 2021-107897 discloses a multi-tier storage device equipped with a guide unit that configures a conveyance path through which sheets pass. The guide unit is movable between an open position where the conveyance path is opened and a forming position where the conveyance path is formed, and includes a locking claw. The locking claw of the guide unit engages with a locking pin provided on a side wall of the multi-tier storage device, thereby locking the guide unit at the forming position. The conveyance path is provided with a conveyance roller pair that conveys sheets, and the conveyance roller pair includes a drive roller and a driven roller that is provided in the guide unit and rotates following the drive roller.

Typically, a driven roller of a conveyance roller pair that conveys sheets is configured to be pressed against a drive roller by an urging member, allowing the sheets to be nipped between the drive roller and the driven roller at a predetermined nip pressure. In particular, sheets with high stiffness, such as cardboard, have a large conveyance resistance when passing through a conveyance path, and thus it has been necessary to increase the nip pressure.

However, in the multi-tier storage device described in Japanese Patent Application Laid-Open Publication No. 2021-107897, when an urging member with a strong urging force is applied to increase a nip pressure, an operating force required to close the guide unit increases.

### SUMMARY

According to a first aspect of the present disclosure, a sheet conveyance apparatus includes a first guide, a second guide configured to be movable between a closed position where the second guide faces the first guide and forms a conveyance path together with the first guide, and an open position where the second guide opens the conveyance path, a conveyance roller pair including a first roller, and a second roller supported by the second guide and configured to nip a sheet together with the first roller so as to convey the sheet on the conveyance path, the second roller being movable, in a case where the second guide is located at the closed position, between a first position where the second roller abuts against the first roller and a second position where the second roller is separated from the first roller, a pressing member configured to press the second roller toward the first roller in a state where the second roller abuts against the first roller, a drive source configured to move the second roller between the first position and the second position, and a control unit configured to execute a separating process of controlling the drive source to position the second roller at the second position, and an abutment process of controlling the drive source so that the second roller moves from the second position to the first position. The second roller is positioned at the second position in a case where the second guide moves from the open position to the closed position.

According to a second aspect of the present disclosure, a sheet conveyance apparatus includes a first guide, a second guide configured to be movable between a closed position where the second guide faces the first guide and forms a conveyance path together with the first guide, and an open position where the second guide opens the conveyance path, a conveyance roller pair including a first roller, and a second roller supported by the second guide and configured to nip a sheet together with the first roller so as to convey the sheet on the conveyance path while abutting against the first roller in a case where the second guide is located at the closed position, a pressing member configured to, when the second guide is located at the closed position, transition between a first state the pressing member presses the second roller toward the first roller with a first pressing force, and a second state where the pressing member presses the second roller toward the first roller with a second pressing force smaller than the first pressing force, a drive source configured to cause the pressing member to transition between the first state and the second state, and a control unit configured to execute a first pressure adjustment process of controlling the drive source so that the pressing member is in the first state, and a second pressure adjustment process of controlling the drive source so that the pressing member is in the second state. The pressing member is in the second state in a case where the second guide moves from the open position to the closed position.

Features of the present disclosure will become apparent from the following description of embodiments with reference to the attached drawings. The following description of embodiments is described by way of example.

### BRIEF DESCRIPTION OF THE DRAWINGS

FIG. 1 is an overall schematic diagram showing a printer according to a first embodiment.

FIG. 2 is a perspective view showing an image forming system.

FIG. 3 is a perspective view showing an upper conveyance unit including an upper conveyance path.

FIG. 4 is a perspective view showing a locking unit.

FIG. 5A is a perspective view showing a pivot unit in a closed state.

FIG. 5B is a perspective view showing the pivot unit in an open state.

FIG. 6 is a side view showing a pressure spring.

FIG. 7 is a front view showing a separation mechanism.

FIG. 8A is a side view showing a driven roller at a pressure position.

FIG. 8B is a side view showing the driven roller at a separation position.

FIG. 9 is a block diagram showing control blocks of the image forming system.

FIG. 10 is a flowchart showing roller separation control.

FIG. 11A is a side view showing a pressure spring in a first state according to a second embodiment.

FIG. 11B is a side view showing the pressure spring in a second state according to the second embodiment.

### DESCRIPTION OF THE EMBODIMENTS

### First Embodiment

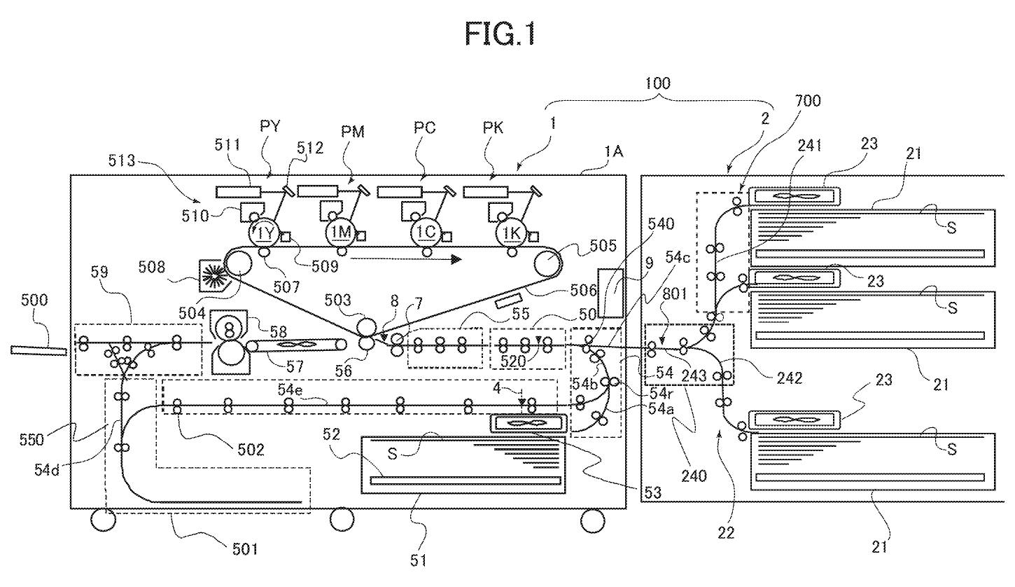

A first embodiment of the present disclosure will be described in detail below with reference to the drawings. As shown in FIG. 1, an image forming system 100 serving as a sheet conveyance apparatus includes an image forming apparatus 1 and a sheet feeding apparatus 2. The image forming apparatus 1 includes a printer, a photocopier, a facsimile, and a multifunction peripheral, and forms an image on a sheet used as a recording medium, based on image information input from an external PC or image information read from a document. In the present embodiment, a full-color laser printer of an electrophotographic system is used as the image forming apparatus 1. Although a full-color laser printer of an electrophotographic system is used as the image forming apparatus 1 in the present embodiment, for example, an image forming apparatus equipped with an image forming unit of an inkjet system instead of an electrophotographic system may be used.

### Overview of Image Forming Apparatus

The image forming apparatus 1 is a POD machine which is capable of printing for purposes other than general office use, and can use a variety of sheets as recording media, including paper such as sheets and envelopes, glossy paper, plastic films such as overhead projector sheets (OHT), and cloth. An apparatus body 1A of the image forming apparatus 1 accommodates a feed cassette 51 that accommodates a sheet S, and an image forming unit 513 that forms an image on the sheet S fed from the feed cassette 51. The image forming unit 513 is a tandem intermediate transfer system equipped with four process units PY, PM, PC, and PK that form yellow, magenta, cyan, and black toner images, and an intermediate transfer belt 506 that serves as an intermediate transfer body. The process units PY to PK are electrophotographic units that each include photosensitive drums 1Y, 1M, 1C, and 1K, that are photosensitive members.

The process units PY to PK are configured similarly to each other except for the color of a toner to be used for development. Thus, the configuration of a process unit and a toner image formation process (image formation operation) will be described using the yellow process unit PY as an example. In addition to the photosensitive drum 1Y, the process unit PY includes an exposing unit 511, a developing apparatus 510, and a drum cleaner 509. The photosensitive drum 1Y is a drum-shaped photosensitive member with a photosensitive layer on its outer periphery, and rotates in the same direction as a rotation direction of the intermediate transfer belt 506. The surface of the photosensitive drum 1Y is charged by supplying electric charge from a charge unit such as a charge roller. The exposing unit 511 emits laser light modulated in accordance with image information and scans the photosensitive drum 1Y using an optical system including a reflecting apparatus 512, thereby drawing an electrostatic latent image on the surface of the photosensitive drum 1Y. The developing apparatus 510 contains a developer containing a toner and supplies the toner to the photosensitive drum 1Y, thereby developing the electrostatic latent image into a toner image. The toner image formed on the photosensitive drum 1Y is primarily transferred to the intermediate transfer belt 506 by a primary transfer roller 507. A residual toner remaining on the photosensitive drum 1Y after transfer is removed by the drum cleaner 509.

The intermediate transfer belt 506 is wound around a drive roller 504, a driven roller 505, an inner secondary transfer roller 503, and a plurality of primary transfer rollers 507, and is driven to rotate clockwise in the drawing by the drive roller 504. The image formation operation described above is performed in parallel in the process units PY to PK, and four color toner images are multi-transferred to overlap each other, forming a full-color toner image on the intermediate transfer belt 506. The toner image is carried by the intermediate transfer belt 506 and conveyed to a secondary transfer unit. The secondary transfer unit is configured as a nip portion between a secondary transfer roller 56 and the inner secondary transfer roller 503, and a bias voltage of opposite polarity to the charge polarity of the toner is applied to the secondary transfer roller 56, thereby secondarily transferring the toner image onto the sheet S. That is, the secondary transfer roller 56 is an example of a transfer unit that transfers the image on the intermediate transfer belt 506 onto the sheet S. A residual toner remaining on the intermediate transfer belt 506 after transfer is removed by a belt cleaner 508.

The sheet S onto which the toner image has been transferred is delivered to a fixing unit 58 by a pre-fixing conveyance unit 57. The fixing unit 58 includes a fixing roller pair that sandwiches and conveys the sheet S, and a heat source such as a halogen heater, and applies heat and pressure to the toner image carried on the sheet S. Accordingly, toner particles melt and adhere, resulting in a fixed image fixed on the sheet S.

### Feed System of Image Forming Apparatus

Next, a description will be given of a configuration and an operation of a sheet conveyance system of the image forming apparatus 1, that feeds the sheet S accommodated in the feed cassette 51 and discharges the sheet S on which an image is formed to outside of the apparatus body. The sheet conveyance system roughly includes a conveyance unit 54, a pre-registration conveyance unit 50, a skew feed correcting portion 55, a registration roller pair 7, a branch conveyance unit 59, and a re-conveyance unit 550.

The feed cassette 51 is removably attached to the apparatus body 1A, and the sheets S stacked on a lift plate 52 that can be lifted and lowered are fed one by one by a sheet feed unit 53. The sheet feed unit 53 includes an adsorption belt provided with a plurality of holes and a suction fan that is driven to create a negative pressure inside the adsorption belt. The uppermost sheet S is floated by an air blowing unit (not shown), adsorbed to the adsorption belt of the sheet feed unit 53, and fed one by one as the adsorption belt rotates. A sheet feeding method by the sheet feed unit 53 is not limited to a belt adsorption method described above, and a friction separation method using a roller or a pad may also be used.

The conveyance unit 54 is an example of a conveyance unit that forms a feed path 54a from the feed cassette 51 toward the image forming unit 513 and conveys the sheet along the feed path 54a. The sheet S transmitted from the sheet feed unit 53 is conveyed along the feed path 54a by a conveyance roller pair 54r of the conveyance unit 54 and delivered to the pre-registration conveyance unit 50.

The pre-registration conveyance unit 50 includes, for example, three conveyance roller pairs, and each of the conveyance roller pairs transmits the sheet S in a sheet conveyance direction. The pre-registration conveyance unit 50 is provided with a sheet sensor 520 that detects a leading edge of the sheet S. That is, the sheet sensor 520 is disposed in the feed path 54a between the feed cassette 51 and the skew feed correcting portion 55 and detects the sheet S being conveyed along the feed path 54a. The sheet sensor 520 may be, for example, a reflective photoelectric sensor including a light-emitting portion and a light-receiving portion. In such a case, light emitted by the light-emitting portion is reflected by the sheet S that has reached a detection position, and the light-receiving portion detects the reflected light, thereby detecting a passing timing of the sheet S. A delay time of the sheet S is measured based on the detection result of the sheet sensor 520, and a conveyance speed of the sheet S in the pre-registration conveyance unit 50 is changed accordingly. After canceling the delay time, the sheet is conveyed to the skew feed correcting portion 55.

The skew feed correcting portion 55 is a side-registration type sheet aligning apparatus equipped with a reference member and, for example, three obliquely conveying rollers. That is, the skew feed correcting portion 55 is disposed between the conveyance unit 54 and the image forming unit 513, and corrects skew feeding of the sheet S while conveying the sheet at a conveyance speed slower than the conveyance speed in the conveyance unit 54. The conveyance speed in the skew feed correcting portion 55 is a speed synchronized with an image to be transferred by the secondary transfer roller 56. After skew feeding correction is performed in the skew feed correcting portion 55, the sheet S is transmitted to the secondary transfer unit by the registration roller pair 7. The skew feeding correction of the sheet by the skew feed correcting portion 55 is not limited to the side-registration type described above. For example, the skew feed correcting portion 55 may correct the skew of the sheet S by abutting the leading edge of the sheet against a nip of a stopped registration roller pair. The skew feed correcting portion 55 may correct the skew of the sheet S by causing the leading edge of the sheet to abut against an abutment surface of a shutter member.

The sheet S, onto which a toner image has been transferred in the secondary transfer unit and the image has been fixed by the fixing unit 58, is conveyed to the branch conveyance unit 59 including a switching member which is capable of switching a conveyance path of the sheet S. In a case where image formation on the sheet S has been completed, the sheet S is discharged by a sheet discharge roller pair to a sheet discharge tray 500 disposed outside of the apparatus body 1A.

In a case where the sheet S is discharged to the sheet discharge tray 500 with a printed side facing downward, the sheet S is conveyed once to a reverse conveyance unit 501, switched back, and then discharged to the sheet discharge tray 500.

In a case where an image is to be formed on a back side of the sheet S, the sheet S is conveyed to the re-conveyance unit 550. The re-conveyance unit 550 includes the reverse conveyance unit 501 and a duplex conveyance unit 502, and conveys the sheet on which an image has been formed by the image forming unit 513 by reversing front and back sides of the sheet, and causes the sheet to merge between the sheet sensor 520 and the feed cassette 51 on the feed path 54a. The re-conveyance unit 550 has a reverse conveyance path 54d that is a reverse path that reverses the conveyance direction of the sheet, and a re-conveyance path 54e that is a duplex conveyance path. The re-conveyance path 54e causes the sheet conveyed from the reverse conveyance path 54d to merge between the sheet sensor 520 and the feed cassette 51 on the feed path 54a.

The sheet S conveyed from the branch conveyance unit 59 is delivered to the duplex conveyance unit 502 having the re-conveyance path 54e via the reverse conveyance unit 501 having the reverse conveyance path 54d. The reverse conveyance unit 501 includes a reverse conveyance roller pair that can rotate forward and backward, and switches back the sheet S to deliver the sheet to the duplex conveyance unit 502. The leading edge of the sheet S conveyed to the duplex conveyance unit 502 is detected by a detection unit 4 that is provided in the re-conveyance path 54e and detects the leading edge of the sheet S. The sheet S is stopped in the re-conveyance path 54e and waits until the sheet is re-fed for image formation on a second side (duplex standby). The detection unit 4 may be, for example, an optical sensor similar to the sheet sensor 520. The duplex conveyance unit 502 conveys the sheet S toward the pre-registration conveyance unit 50 in accordance with a timing for the image formation on the second side. That is, the re-conveyance unit 550 temporarily stops the sheet on the re-conveyance path 54e and then starts conveying the sheet toward the skew feed correcting portion 55. After an image is formed on the back side of the sheet S, the sheet S is discharged to the sheet discharge tray 500.

### Sheet Feeding Apparatus

As shown in FIG. 1, the sheet feeding apparatus 2 is connected to an upstream side of a horizontal path 54c of the image forming apparatus 1. The sheet feeding apparatus 2 includes three vertically aligned feed decks 21 and sheet feed units 23, each of which has a configuration similar to that of the feed cassette 51 of the image forming apparatus 1. The sheets S accommodated in each of the feed decks 21 are fed by the sheet feed unit 23.

Similarly to the image forming apparatus 1, the sheet S is fed by the sheet feed unit 23 in accordance with an image formation timing of the image forming apparatus 1. The fed sheet S is conveyed to a registration unit 240 by a conveyance unit 22. More specifically, the sheet S fed from the first and second uppermost feed decks 21 are conveyed to the registration unit 240 via an upper conveyance path 241. The sheet S fed from the third uppermost feed deck 21 is conveyed to the registration unit 240 via a lower conveyance path 242. The sheet feeding apparatus 2 includes an upper conveyance unit 700 that includes the upper conveyance path 241.

The registration unit 240 is provided with a horizontal path 243 extending in the horizontal direction, and a sheet detection sensor 801 that detects the sheet S is provided on the horizontal path 243. The sheet detection sensor 801 may be, for example, an optical sensor similar to the sheet sensor 520. When the sheet detection sensor 801 detects the leading edge of the sheet S, the sheet S temporarily stops on the horizontal path 243.

More specifically, the registration unit 240 includes a registration roller pair 245, the sheet S abuts against a nip of the registration roller pair 245 in a stopped state, thereby correcting the skew of the sheet S. In such a state, the sheet S is temporarily stopped. The registration roller pair 245 then re-feeds the sheet S in accordance with the image formation timing of the image forming apparatus 1, and conveys the sheet S to the image forming apparatus 1. Accordingly, it is possible to correct any variations in a conveyance timing that occur in the sheet feed unit 23. The sheet feed unit 23 and the conveyance unit 22 of the sheet feeding apparatus 2 can be controlled by a control unit 9 of the image forming apparatus 1.

The sheet S conveyed along the horizontal path 243 is delivered to the horizontal path 54c of the image forming apparatus 1. The feed path 54a also includes a curved path 54b that is curved, and the curved path 54b and the horizontal path 54c merge at a merging portion 540. The conveyance path from the horizontal path 243 of the sheet feeding apparatus 2 to the sheet discharge tray 500 extends linearly in a substantially horizontal direction. Thereby, it is possible to reduce a conveyance resistance of the sheet and reduce load and damage to the sheet.

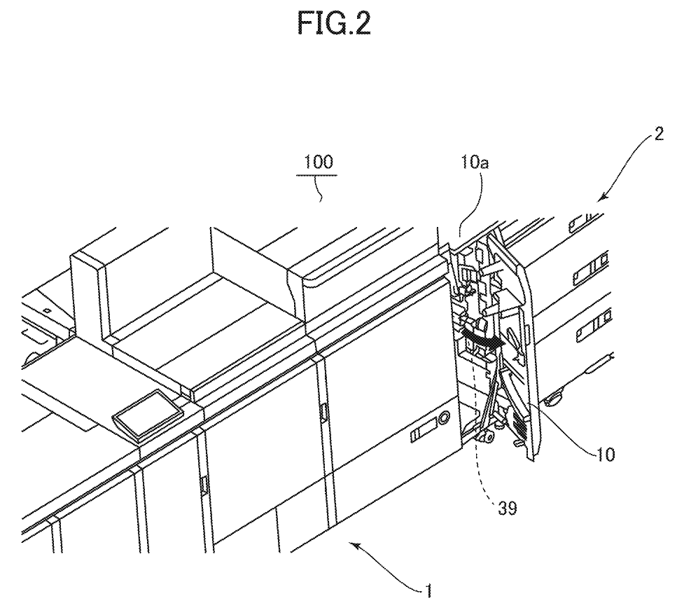

FIG. 2 is a perspective view showing the image forming system 100. As shown in FIGS. 1 and 2, in a case where the sheet S jams near the merging portion 540 of the image forming apparatus 1, a user opens a front door 10 of the sheet feeding apparatus 2. The front door 10 serving as a door can be opened and closed with respect to a main body 10a that accommodates the upper conveyance path 241. Then, the user can resolve the jam (sheet jam) that has occurred near the merging portion 540 by opening a door portion 39 of the image forming apparatus 1.

### Upper Conveyance Unit

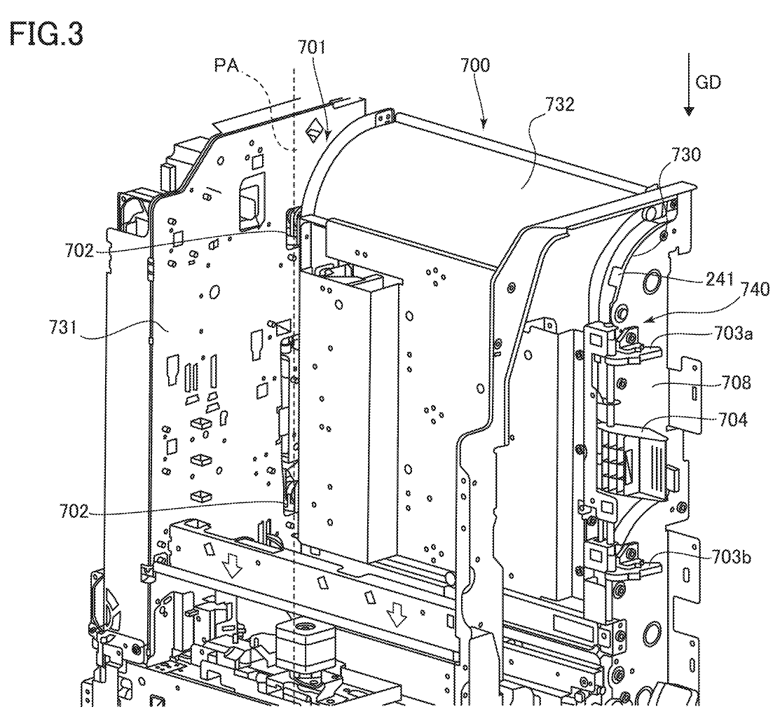

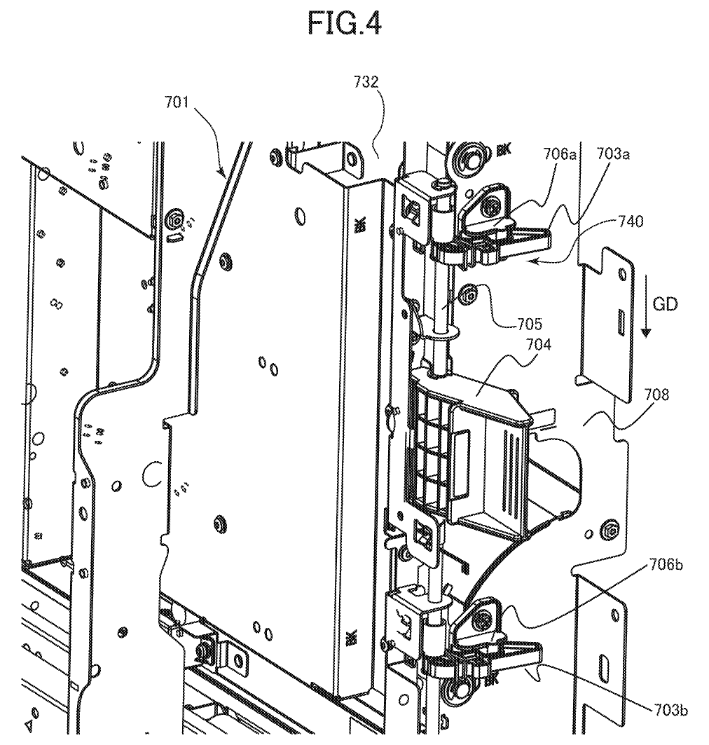

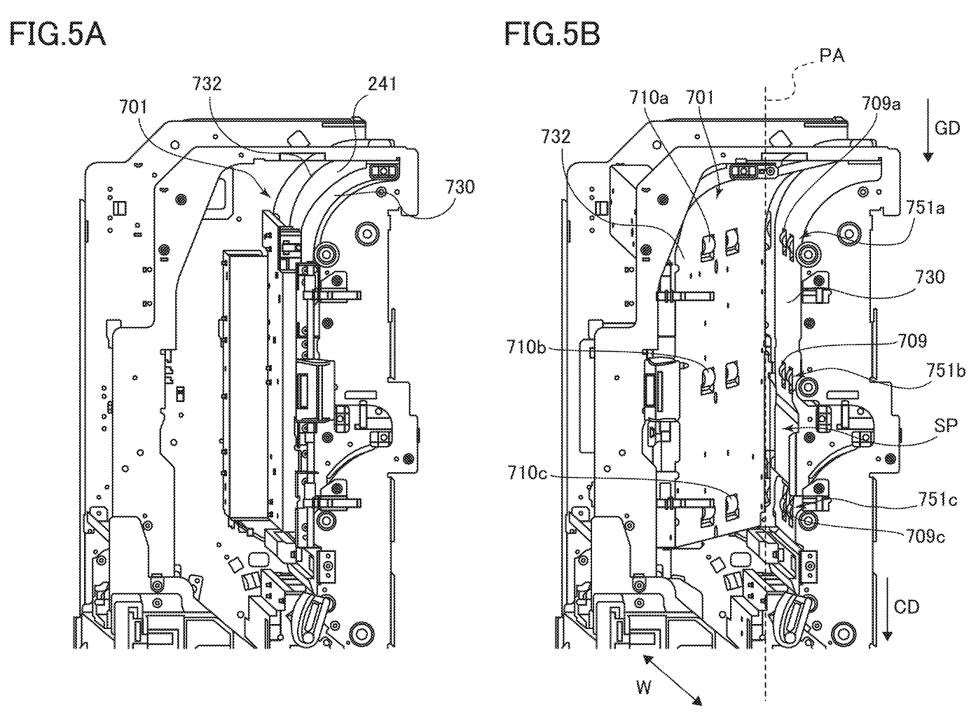

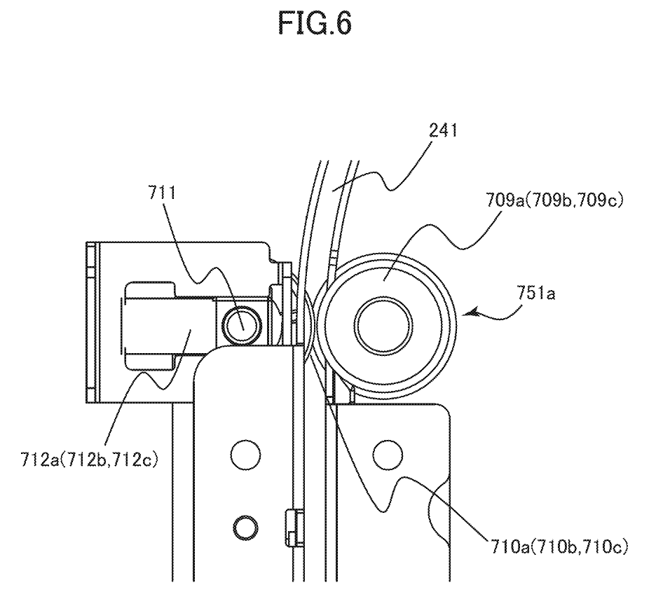

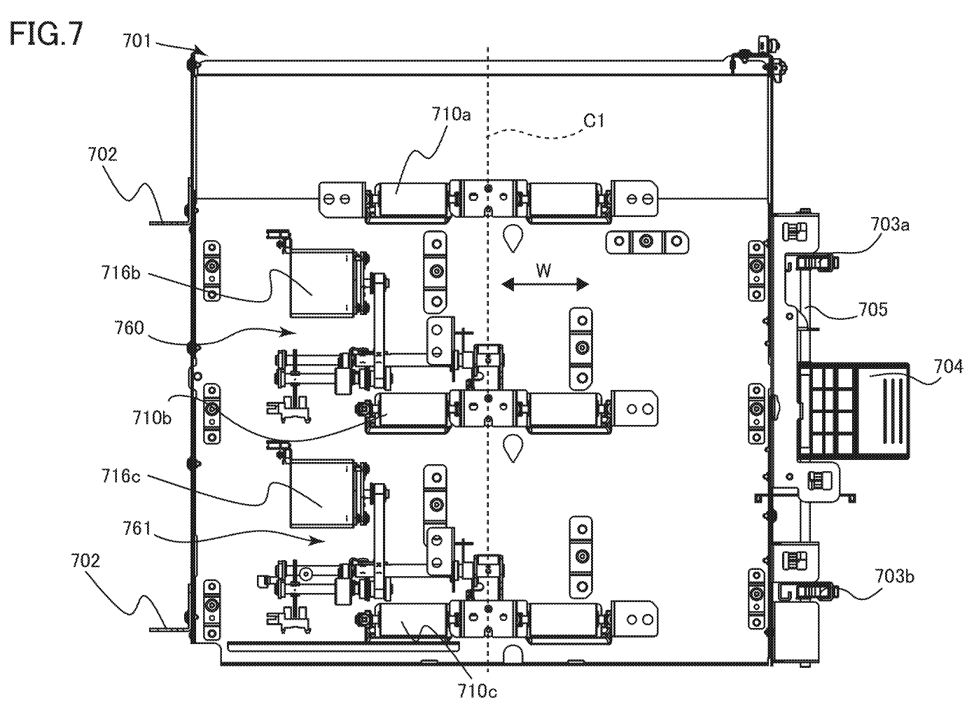

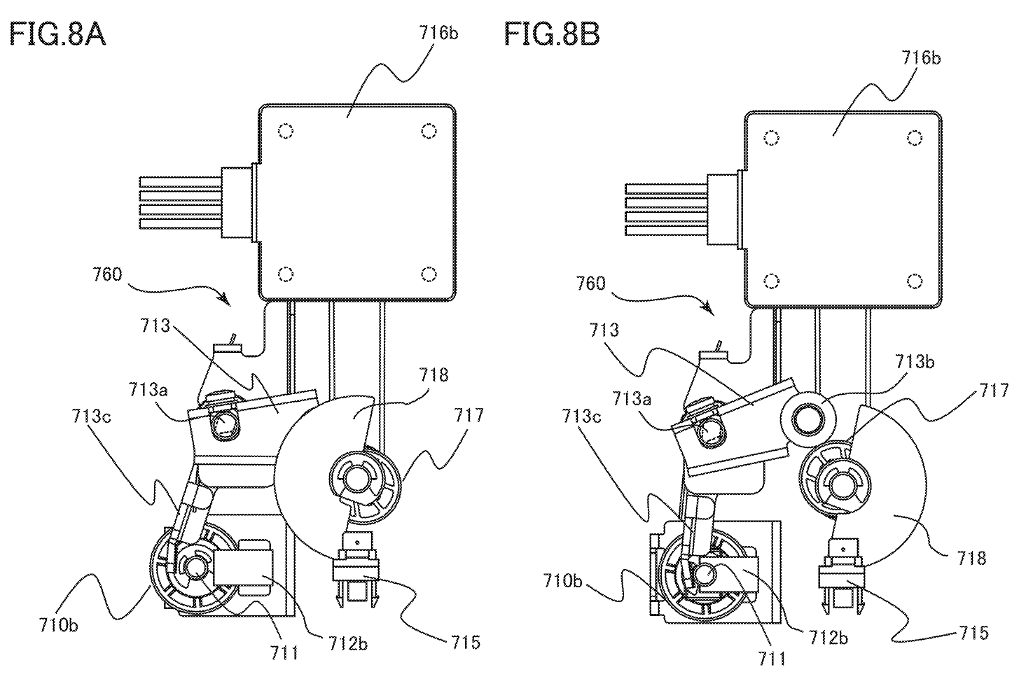

Next, the configuration of the upper conveyance unit 700 near the upper conveyance path 241 will be described with reference to FIGS. 3 to 8B. FIG. 3 is a perspective view showing the upper conveyance unit 700 including the upper conveyance path 241. FIG. 4 is a perspective view showing a locking unit 740. FIG. 5A is a perspective view showing a pivot unit 701 in a closed state, and FIG. 5B is a perspective view showing the pivot unit 701 in an open state. FIG. 6 is a side view showing a pressure spring 712. FIG. 7 is a front view showing separation mechanisms 760 and 761. FIG. 8A is a side view showing a driven roller 710b located at a pressure position, and FIG. 8B is a side view showing the driven roller 710b located at a separation position.

As shown in FIG. 3, the upper conveyance unit 700 includes a fixed guide 730 serving as a first guide and the pivot unit 701 serving as a second guide. The fixed guide 730 is fixed to a front frame 708 and a rear frame 731 of the sheet feeding apparatus 2. The pivot unit 701 includes two hinges 702 pivotably provided on the rear frame 731, and the two hinges 702 are disposed side by side in a vertical direction.

The pivot unit 701 includes a pivot guide 732 that is movable between a closed position and an open position by the hinges 702. At the closed position, the pivot guide 732 faces the fixed guide 730 and forms the upper conveyance path 241 together with the fixed guide 730. At the open position, the pivot guide 732 opens the upper conveyance path 241. Thereby, as shown in FIG. 5B, an open space SP is formed in a front direction of the upper conveyance path 241. In a case where the sheet S jams in the upper conveyance path 241 serving as the conveyance path, the user can remove the jammed sheet S from the open space SP.

When the pivot guide 732 is located at the closed position, the pivot unit 701 is also at the closed position, and when the pivot guide 732 is located at the open position, the pivot unit 701 is also at the open position. As shown in FIGS. 3 and 5B, the pivot guide 732 and the pivot unit 701 are configured to be pivotable between the closed position and the open position around a pivot axis PA extending in a gravity direction GD.

Furthermore, the upper conveyance unit 700 includes the locking unit 740 that holds the pivot guide 732 at the closed position. As shown in FIGS. 3 and 4, the locking unit 740 includes locked portions 706a and 706b, that are provided on the front frame 708 and each of which partially has a boss shape, and hook portions 703a and 703b that are provided on the pivot guide 732. The hook portions 703a and 703b, that serve as first and second locking portions, are connected by a hook shaft 705 extending in the gravity direction GD, and an operation lever 704 is fixed to the hook shaft 705. The user can pivot the hook portions 703a and 703b in the horizontal direction around the hook shaft 705 by operating the operation lever 704 in the left-right direction.

When the pivot guide 732 is located at the closed position, the hook portions 703a and 703b are respectively locked with locked portions 706a and 706b that serve as first and second locked portions, thereby holding the pivot unit 701 at the closed position. Thereby, when the upper conveyance unit 700 conveys the sheet S, the pivot unit 701 can be positioned at the closed position. When the pivot unit 701 is moved to the open position, the user operates the operation lever 704 to disengage the hook portions 703a and 703b from the lock portions 706a and 706b. In such a state, the user can further move the operation lever 704 leftward in FIG. 4 to pivot the pivot unit 701 from the closed position to the open position, thereby opening the upper conveyance path 241.

As shown in FIG. 5B, the upper conveyance path 241 is provided with conveyance roller pairs 751a, 751b, and 751c at three positions aligned in the gravity direction GD. Furthermore, at each of the three positions, two conveyance roller pairs are aligned in a sheet width direction W, that is orthogonal to a sheet conveyance direction CD. Since the two conveyance roller pairs aligned in the sheet width direction W have the same configuration, the configurations of the conveyance roller pairs 751a, 751b, and 751c aligned in the gravity direction GD will be described below. The sheet conveyance direction CD, in which the conveyance roller pairs 751a, 751b, and 751c convey the sheet S, is parallel to the gravity direction GD. The conveyance roller pairs 751a, 751b, and 751c are aligned in order from upstream to downstream in the sheet conveyance direction CD.

The conveyance roller pair 751a includes a drive roller 709a to which a driving force is input, and a driven roller 710a that is supported by the pivot guide 732 and rotates following the drive roller 709a. The conveyance roller pair 751b, that serves as a first conveyance roller pair, includes a drive roller 709b serving as a first roller to which a driving force is input, and a driven roller 710b serving as a second roller that is supported by the pivot guide 732 and rotates following the drive roller 709b. The conveyance roller pair 751c, that serves as a second conveyance roller pair, includes a drive roller 709c serving as a third roller to which a driving force is input, and a driven roller 710c serving as a fourth roller that is supported by the pivot guide 732 and rotates following the drive roller 709c.

As shown in FIG. 6, the driven roller 710a includes a roller shaft 711 and is pressed toward the drive roller 709a by a pressure spring 712a. Similarly, the driven rollers 710b and 710c are pressed toward the drive rollers 709b and 709c by pressure springs 712b and 712c, respectively. As such, the pressure springs 712a, 712b, and 712c bring the driven rollers 710a, 710b, and 710c into pressure contact with the drive rollers 709a, 709b, and 709c, allowing each of the conveyance roller pairs 751a, 751b, and 751c to obtain a conveyance force required to convey the sheet S. The pressure springs 712b and 712c configure a first pressing member and a second pressing member, respectively.

As shown in FIG. 7, the pivot unit 701 includes separation mechanisms 760 and 761. The driven roller 710b of the conveyance roller pair 751b and the driven roller 710c of the conveyance roller pair 751c are configured to be movable between pressure positions as first and third positions and separation positions as second and fourth positions, respectively.

When the pivot guide 732 is located at the closed position, the driven rollers 710b and 710c can abut against the drive rollers 709b and 709c at the pressure position to sandwich and convey the sheet S together with the drive rollers 709b and 709c on the upper conveyance path 241. Furthermore, when the pivot guide 732 is located at the closed position, the driven rollers 710b and 710c are separated from the drive rollers 709b and 709c at the separation position. The driven rollers 710b and 710c are located at the pressure position when the image forming system 100 is performing an image formation operation.

The separation mechanism 760 includes a separation motor 716b, and can move the driven roller 710b between the pressure position and the separation position by driving the separation motor 716b. Similarly, the separation mechanism 761 includes a separation motor 716c serving as a second drive source, and can move the driven roller 710c between the pressure position and the separation position by driving the separation motor 716c. Since the separation mechanisms 760 and 761 have similar configurations, only the separation mechanism 760 will be described below.

As shown in FIGS. 8A and 8B, the separation mechanism 760 includes the separation motor 716b serving as a drive source and a first drive source, a separation cam 717, a cam follower 713, a cam sensor 715, and a light blocking plate 718. The separation cam 717 is configured to be rotatable by driving the separation motor 716b, and the light blocking plate 718 is provided coaxially with the separation cam 717. The light blocking plate 718 is configured to rotate integrally with the separation cam 717 and to block an optical path of the cam sensor 715. The light blocking plate 718 has a fan shape with a central angle of approximately 180°, and the control unit 9 (see FIG. 1) can rotate the separation cam 717 in 180° increments based on a detection result of the cam sensor 715.

The cam follower 713 is configured to be pivotable about a pivot shaft 713a and includes a pressed portion 713b and a pressure lever portion 713c. As shown in FIG. 8A, when the separation cam 717 is rotated 180° with the driven roller 710b located at the pressure position, the separation cam 717 presses the pressed portion 713b of the cam follower 713. Then, the cam follower 713 rotates counterclockwise about the pivot shaft 713a, and the pressure lever portion 713c presses the roller shaft 711 of the driven roller 710b against the pressing force of the pressure spring 712b serving as a pressing member. Thereby, the driven roller 710b moves from the pressure position to the separation position, as shown in FIG. 8B.

When the leading edge of the sheet S conveyed to the upper conveyance path 241 abuts against the registration roller pair 245 and the skew of the sheet S is corrected, a trailing edge of the sheet S may be located between the conveyance roller pair 751b and the conveyance roller pair 751a in the sheet conveyance direction CD. Therefore, when the registration roller pair 245 corrects the skew of the sheet S, the separation mechanisms 760 and 761 move the driven rollers 710b and 710c from the pressure position to the separation position. Thereby, the sheet S can form a loop, and the skew of the sheet S can be properly corrected.

Recently, there has been a demand for image forming systems which is capable of printing on a variety of sheets (media), ranging from ultra-thin paper with a grammage of approximately 45 g/m² to 50 g/m² to ultra-thick paper with a grammage of approximately 500 g/m². In particular, in a case where the sheet S being conveyed is thick or ultra-thick paper, a conveyance resistance increases as the sheet passes through a conveyance path, thereby increasing a conveyance force required to convey the sheet S. Increasing the conveyance force requires increasing the nip pressure of the conveyance roller pair. However, for example, when a spring pressure of the pressure springs 712a, 712b, and 712c is increased to increase the nip pressure of the conveyance roller pairs 751a, 751b, and 751c provided in the upper conveyance path 241, an operating force required to close the pivot unit 701 increases.

More specifically, increasing the spring pressure of the pressure springs 712a, 712b, and 712c increases a force compressing the drive rollers 709a, 709b, and 709c when moving the pivot unit 701 to the closed position, and the user needs to close the pivot unit 701 using a force equal to or greater than the compression force. Thus, the operating force required to close the pivot unit 701 is increased, thereby reducing operability. In the present embodiment, the conveyance force required to convey ultra-thick paper is 3 [kgf] per conveyance roller pair. Therefore, a force of 9 kgf or greater is required to close the pivot unit 701, and a large operating force is required to close the pivot unit 701. Consequently, in the present embodiment, the separation mechanisms 760 and 761 are used to reduce the operating force when closing the pivot unit 701.

### Control Blocks

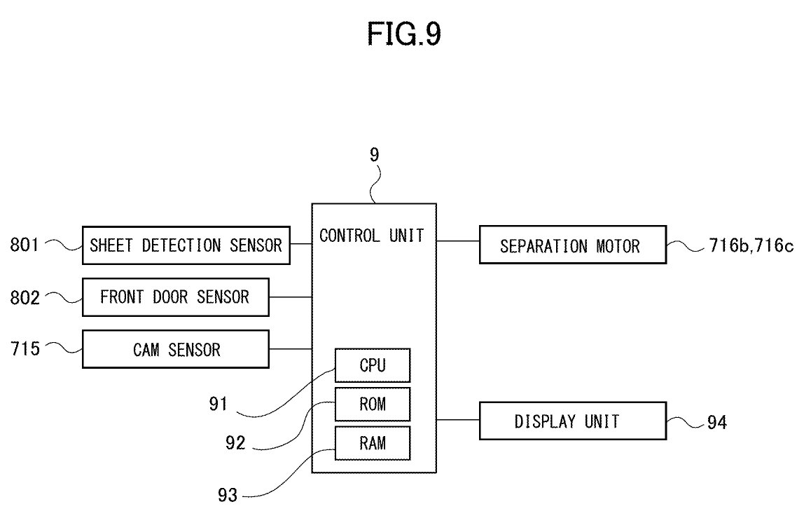

FIG. 9 is a block diagram showing control blocks of the image forming system 100. As shown in FIGS. 1 and 9, the image forming apparatus 1 of the image forming system 100 includes the control unit 9. The control unit 9 includes a central processing unit (CPU) 91, a read only memory (ROM) 92, and a random access memory (RAM) 93. The CPU 91 reads and executes various programs stored in the ROM 92. The RAM 93 is used as a working area for the CPU 91.

The sheet detection sensor 801 serving as a jam detection unit, a front door sensor 802, and the cam sensor 715 are connected to an input side of the control unit 9. The front door sensor 802 detects whether the front door 10 of the sheet feeding apparatus 2 shown in FIG. 2 is open or closed. The separation motors 716b and 716c are connected to an output side of the control unit 9. Furthermore, a display unit 94 configured with a touch panel or the like is connected to the control unit 9.

### Roller Separation Control

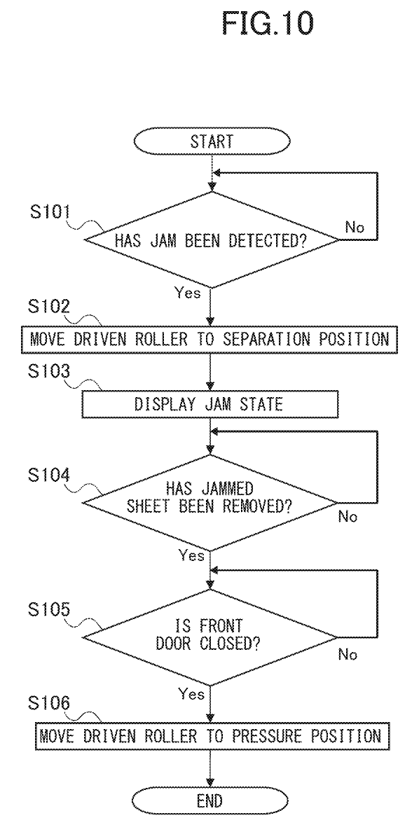

Next, roller separation control of the image forming system 100 will be described with reference to FIG. 10. FIG. 10 is a flowchart showing the roller separation control. When the roller separation control is started, the control unit 9 determines whether a jam has been detected in the upper conveyance path 241 based on a detection result of the sheet detection sensor 801 (step S101). In a case where it is determined that a jam has been detected (step S101: Yes), the control unit 9 moves the driven roller 710b of the central conveyance roller pair 751b among the three conveyance roller pairs 751a to 751c from the pressure position to the separation position (step S102). That is, the control unit 9 drives the separation motor 716b so that the separation cam 717 rotates 180°, thereby executing a separating process (first separating process) of positioning the driven roller 710b at the separation position.

Next, the control unit 9 displays a jammed state on the display unit 94 to notify the user of the jammed state (step S103). The control unit 9 then determines whether the jammed sheet S has been removed, based on the detection result of the sheet detection sensor 801 (step S104). In a case where it is determined that the jammed sheet S has been removed, that is, the jam has been resolved (step S104: Yes), the control unit 9 determines whether the front door 10 is closed, based on the detection result of the front door sensor 802 (step S105).

In a case where it is determined that the front door 10 is closed (step S105: Yes), the driven roller 710b is moved from the separation position to the pressure position (step S106). That is, the control unit 9 executes an abutment process (first abutment process) of driving the separation motor 716b so that the separation cam 717 rotates 180°, thereby moving the driven roller 710b from the separation position to the pressure position. By the above process, the roller separation control is completed. The display unit 94, that has displayed the jam state, may cancel the jam display between steps S104 and S105 or between steps S105 and S106.

In the roller separation control described above, in order to remove the jammed sheet S, the user opens the front door 10 to expose the pivot guide 732 to the outside of the sheet feeding apparatus 2. Furthermore, in order to open the upper conveyance path 241, the user moves the pivot guide 732 from the closed position to the open position. After removing the jammed sheet S, the user moves the pivot guide 732 from the open position to the closed position and locks the pivot unit 701 at the closed position by the locking unit 740. Thereafter, the user closes the front door 10, completing the jam resolution.

As described in steps S105 and S106, the driven roller 710b is moved to the pressure position after the front door 10 is closed. That is, the driven roller 710b is located at the separation position when the pivot guide 732 moves from the open position to the closed position. The driven roller 710b located at the separation position is separated from the drive roller 709b even when the pivot unit 701 is closed from the open position to the closed position. Therefore, when the pivot unit 701 is closed, the drive roller 709b and the driven roller 710b do not come into contact with each other, and thus a resistance force when closing the pivot unit 701 is reduced by a magnitude of the nip pressure of the conveyance roller pair 751b. In other words, an operating force required to move the pivot guide 732 from the open position to the closed position is reduced, making it possible to improve operability.

As shown in FIG. 7, the hook portions 703a and 703b are disposed on a first side with respect to a center C1 of the upper conveyance path 241 in the sheet width direction W, and the pivot axis PA of the pivot unit 701 is disposed on a second side with respect to the center C1 of the upper conveyance path 241. Furthermore, the separation motors 716b and 716c are disposed on the same side of the center C1 of the upper conveyance path 241 as the pivot axis PA in the sheet width direction W. As such, by disposing the separation motors 716b and 716c, that are heavy objects, on the back side of the sheet feeding apparatus 2 and near the pivot axis PA of the pivot unit 701, the operating force when pivoting the pivot unit 701 can be reduced. Furthermore, it is easy to ensure the open space SP when the pivot unit 701 is opened.

The conveyance roller pair 751b, that includes the driven roller 710b to be moved to the separation position by the roller separation control described with reference to FIG. 10, is disposed between the locked portions 706a and 706b in the sheet conveyance direction CD. Therefore, when the driven roller 710b moves from the pressure position to the separation position in step S102, the hook portions 703a and 703b are locked to (engage with) the locked portions 706a and 706b at upper and lower positions of the driven roller 710b. Thus, even when the driven roller 710b moves, the pivot unit 701 can be stably held at the closed position, making it possible to prevent the pivot unit 701 from being damaged.

Furthermore, since the roller separation control is performed using the separation mechanisms 760 and 761 that are used when the registration roller pair 245 corrects the skew of the sheet S, an increase in costs can be curbed.

### Second Embodiment

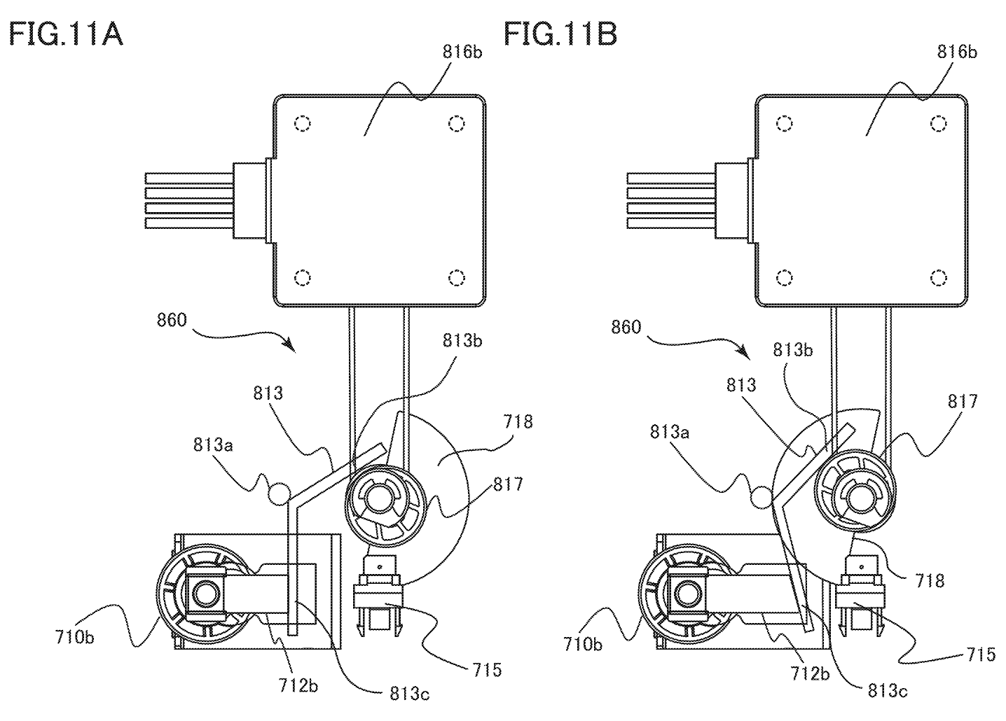

Next, a second embodiment of the present disclosure will be described. The second embodiment is configured by applying a pressing force adjustment mechanism 860 instead of the separation mechanism 760 of the first embodiment. Therefore, the same components as those in the first embodiment will be omitted in the drawings or will be described by using the same reference numerals in the drawings. FIG. 11A is a side view showing the pressure spring 712b in a first state, and FIG. 11B is a side view showing the pressure spring 712b in a second state.

As shown in FIGS. 11A and 11B, the pressing force adjustment mechanism 860 includes a pressure variable motor 816b serving as a drive source, a pressure variable cam 817, a cam follower 813, the cam sensor 715, and the light blocking plate 718. The pressure variable cam 817 is configured to be rotatable by driving the pressure variable motor 816b, and the light blocking plate 718 is provided coaxially with the pressure variable cam 817. The light blocking plate 718 is configured to rotate integrally with the pressure variable cam 817 and to block an optical path of the cam sensor 715. The control unit 9 (see FIG. 1) can rotate the pressure variable cam 817 in 180° increments based on a detection result of the cam sensor 715.

The cam follower 813 is configured to be pivotable about a pivot shaft 813a and includes a pressed portion 813b and a pressure variable lever portion 813c. The pressure spring 712b is compressed between the driven roller 710b and the pressure variable lever portion 813c and can transition to the first state shown in FIG. 11A and the second state shown in FIG. 11B as the pressure variable lever portion 813c moves. When the pivot unit 701 including the pivot guide 732 is located at the closed position, the pressure spring 712b presses the driven roller 710b toward the drive roller 709b with a first pressing force in the first state. Furthermore, when the pivot unit 701 including the pivot guide 732 is located at the closed position, the pressure spring 712b presses the driven roller 710b toward the drive roller 709b with a second pressing force smaller than the first pressing force in the second state. That is, the pressure spring 712b in the second state is longer than the pressure spring 712b in the first state.

As shown in FIG. 11A, when the pressure variable cam 817 is rotated 180° while the pressure spring 712b is in the first state, the pressure variable cam 817 presses the pressed portion 813b of the cam follower 813. Then, the cam follower 813 rotates counterclockwise about the pivot shaft 813a, causing the pressure variable lever portion 813c to pull the pressure spring 712b from the first state. Thereby, the driven roller 710b transitions from the first state to the second state, as shown in FIG. 11B. A configuration similar to the pressing force adjustment mechanism 860 is also provided near the pressure spring 712c, allowing the pressure spring 712c to transition between the first state and the second state.

In the present embodiment, the control unit 9 can execute pressure variable control to reduce the operating force required to move the pivot guide 732 from the open position to the closed position and improve operability. The pressure variable control is similar to the roller separation control in FIG. 10 except for steps S102 and S106 in FIG. 10. That is, in the pressure variable control, instead of step S102 in FIG. 10, the pressure spring 712b is made to transition from the first state to the second state, and instead of step S106, the pressure spring 712b is made to transition from the second state to the first state.

In other words, the control unit 9 can execute a second pressure adjustment process of driving the pressure variable motor 816b so that the pressure variable cam 817 rotates 180°, thereby setting the pressure spring 712b to be in the second state. The control unit 9 can also execute a first pressure adjustment process of driving the pressure variable motor 816b so that the pressure variable cam 817 rotates 180°, thereby setting the pressure spring 712b to be in the first state.

That is, the pressure spring 712b is in the second state when the pivot guide 732 moves from the open position to the closed position. The pressure spring 712b in the second state presses the driven roller 710b with a pressing force smaller than that of the pressure spring 712b in the first state. Therefore, when the pivot unit 701 is closed, a resistance force when closing the pivot unit 701 decreases by a magnitude of decrease in the pressing force of the pressure spring 712b that has transitioned from the first state to the second state.

Thus, it is possible to reduce an operating force required to move the pivot guide 732 from the open position to the closed position when the pivot unit 701 is closed is reduced, and to improve operability. Furthermore, the same effects as those of the first embodiment can be achieved.

### Other Embodiments

In the first embodiment, in step S102 of the roller separation control, only the driven roller 710b of the middle conveyance roller pair 751b among the three conveyance roller pairs 751a to 751c on the upper conveyance path 241 is moved from the pressure position to the separation position, but this is not limiting. For example, in step S102 of the roller separation control, both the driven rollers 710b and 710c of the conveyance roller pairs 751b and 751c among the three conveyance roller pairs 751a to 751c may be moved from the pressure position to the separation position. Here, a process of moving the driven roller 710c from the pressure position to the separation position is a second separating process, and a process of moving the driven roller 710c from the separation position to the pressure position is a second abutment process.

Similarly, in the pressure variable control of the second embodiment, only the pressure spring 712b that presses the driven roller 710b of the middle conveyance roller pair 751b among the three conveyance roller pairs 751a to 751c on the upper conveyance path 241 is moved from the first state to the second state, but this is not limiting. For example, in the pressure variable control, both the pressure springs 712b and 712c that press the driven rollers 710b and 710c of the conveyance roller pairs 751b and 751c among the three conveyance roller pairs 751a to 751c may be moved from the first state to the second state.

Furthermore, among the conveyance roller pairs 751a and 751b, the conveyance roller pair 751a located most upstream in the sheet conveyance direction CD is not provided with a separation mechanism or a pressing force adjustment mechanism, but this is not limiting. A separation mechanism or a pressing force adjustment mechanism may be provided near the conveyance roller pair 751a to execute the roller separation control or the pressure variable control.

In the first embodiment, step S102 in FIG. 10 is executed based on the detection of a jam, but the process of step S102 may be performed at any time before the pivot unit 701 is moved from the open position to the closed position after the jam resolution is completed. This is also applied to the process of causing the pressure spring 712b to transition from the first state to the second state in the second embodiment.

In the first embodiment, step S102 in FIG. 10 is executed based on the detection of a jam, but this is not limiting. For example, step S102 in FIG. 10 may be performed based on the opening of the front door 10. This also applies to the process of causing the pressure spring 712b to transition from the first state to the second state in the second embodiment.

In all of the above-described embodiments, in the conveyance roller pairs provided on the upper conveyance path 241, the drive roller is provided on the fixed guide 730 side, and the driven roller is provided on the pivot guide 732 side, but this is not limiting. For example, the drive roller may be provided on the pivot guide 732 side, and the driven roller may be provided on the fixed guide 730 side.

According to the present disclosure, it is possible to reduce an operating force required to move the second guide from the open position to the closed position.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-024580, filed February 18, 2025, which is hereby incorporated by reference herein in its entirety.

What is claimed is:

1. A sheet conveyance apparatus comprising:
a first guide;
a second guide configured to be movable between a closed position where the second guide faces the first guide and forms a conveyance path together with the first guide, and an open position where the second guide opens the conveyance path;
a conveyance roller pair including:
a first roller; and
a second roller supported by the second guide and configured to nip a sheet together with the first roller so as to convey the sheet on the conveyance path, the second roller being movable, in a case where the second guide is located at the closed position, between a first position where the second roller abuts against the first roller and a second position where the second roller is separated from the first roller;
a pressing member configured to press the second roller toward the first roller in a state where the second roller abuts against the first roller;
a drive source configured to move the second roller between the first position and the second position; and
a control unit configured to execute a separating process of controlling the drive source to position the second roller at the second position, and an abutment process of controlling the drive source so that the second roller moves from the second position to the first position,
wherein the second roller is positioned at the second position in a case where the second guide moves from the open position to the closed position.

2. The sheet conveyance apparatus according to claim 1, further comprising a locking unit configured to hold the second guide at the closed position.

3. The sheet conveyance apparatus according to claim 2, wherein the locking unit includes:
a first locked portion;
a second locked portion; and
a first locking portion and a second locking portion which are provided on the second guide and are configured to be locked to the first locked portion and the second locked portion, respectively, and
the conveyance roller pair is disposed between the first locked portion and the second locked portion in a sheet conveyance direction in which the conveyance roller pair conveys the sheet.

4. The sheet conveyance apparatus according to claim 3, wherein the second guide is configured to be pivotable between the closed position and the open position around a pivot axis extending in a gravity direction.

5. The sheet conveyance apparatus according to claim 4, wherein the first locking portion and the second locking portion are disposed on a first side with respect to a center of the conveyance path in a sheet width direction orthogonal to the sheet conveyance direction, and
the pivot axis is disposed on a second side with respect to the center of the conveyance path in the sheet width direction.

6. The sheet conveyance apparatus according to claim 5, wherein the drive source is supported by the second guide and is disposed on the same side with respect to the center of the conveyance path as the pivot axis in the sheet width direction.

7. The sheet conveyance apparatus according to claim 1, wherein the conveyance roller pair, the pressing member, the drive source, the separating process, and the abutment process are a first conveyance roller pair, a first pressing member, a first drive source, a first separating process, and a first abutment process, respectively,
the sheet conveyance apparatus further includes:
a second conveyance roller pair including a third roller, and a fourth roller supported by the second guide and configured to nip a sheet together with the third roller so as to convey the sheet on the conveyance path, the fourth roller being movable, in a case where the second guide is located at the closed position, between a third position where the fourth roller abuts against the third roller and a fourth position where the fourth roller is separated from the third roller;
a second pressing member configured to press the fourth roller toward the third roller in a state where the fourth roller abuts against the third roller; and
a second drive source configured to move the fourth roller between the third position and the fourth position,
the second conveyance roller pair is disposed downstream of the first conveyance roller pair in a sheet conveyance direction in which the first conveyance roller pair conveys the sheet,
the control unit is configured to execute a second separating process of controlling the second drive source so that the fourth roller is positioned at the fourth position, and a second abutment process of controlling the second drive source so that the fourth roller moves from the fourth position to the third position, and
the fourth roller is positioned at the fourth position in a case where the second guide moves from the open position to the closed position.

8. The sheet conveyance apparatus according to claim 1, further comprising:
a main body configured to accommodate the first guide and the second guide;
a door configured to be opened with respect to the main body to expose the first guide and the second guide; and
a jam detection unit configured to detect that a sheet has jammed on the conveyance path,
wherein the control unit executes the separating process based on detection, by the jam detection unit, of a sheet jam occurring in the conveyance path, and executes the abutment process based on resolution of the sheet jam in the conveyance path and closing of the door with respect to the main body.

9. The sheet conveyance apparatus according to claim 1, further comprising:
a main body configured to accommodate the first guide and the second guide; and
a door configured to be opened with respect to the main body to expose the first guide and the second guide,
wherein the control unit executes the separating process based on the door being opened with respect to the main body, and executes the abutment process based on the door being closed with respect to the main body.

10. A sheet conveyance apparatus comprising:
a first guide;
a second guide configured to be movable between a closed position where the second guide faces the first guide and forms a conveyance path together with the first guide, and an open position where the second guide opens the conveyance path;
a conveyance roller pair including:
a first roller; and
a second roller supported by the second guide and configured to nip a sheet together with the first roller so as to convey the sheet on the conveyance path while abutting against the first roller in a case where the second guide is located at the closed position;
a pressing member configured to, when the second guide is located at the closed position, transition between a first state the pressing member presses the second roller toward the first roller with a first pressing force, and a second state where the pressing member presses the second roller toward the first roller with a second pressing force smaller than the first pressing force;
a drive source configured to cause the pressing member to transition between the first state and the second state; and
a control unit configured to execute a first pressure adjustment process of controlling the drive source so that the pressing member is in the first state, and a second pressure adjustment process of controlling the drive source so that the pressing member is in the second state,
wherein the pressing member is in the second state in a case where the second guide moves from the open position to the closed position.

11. The sheet conveyance apparatus according to claim 10, further comprising:
a locking unit configured to hold the second guide at the closed position.

12. The sheet conveyance apparatus according to claim 11,
wherein the locking unit includes:
a first locked portion;
a second locked portion; and
a first locking portion and a second locking portion which are provided on the second guide and are configured to be locked to the first locked portion and the second locked portion, respectively, and
the conveyance roller pair is disposed between the first locked portion and the second locked portion in a sheet conveyance direction in which the conveyance roller pair conveys the sheet.

13. The sheet conveyance apparatus according to claim 12, wherein the second guide is configured to be pivotable between the closed position and the open position around a pivot axis extending in a gravity direction.

14. The sheet conveyance apparatus according to claim 13, wherein the first locking portion and the second locking portion are disposed on a first side with respect to a center of the conveyance path in a sheet width direction orthogonal to the sheet conveyance direction, and
the pivot axis is disposed on a second side with respect to the center of the conveyance path in the sheet width direction.

15. The sheet conveyance apparatus according to claim 14, wherein the drive source is supported by the second guide and is disposed on the same side with respect to the center of the conveyance path as the pivot axis in the sheet width direction.
